(19) United States
(12) Patent Application Publication
(10) Pub. No.: US 2015/0196024 A1
(43) Pub. Date: Jul. 16, 2015

(54) PARTICLE SIZE REDUCTION

(71) Applicant: AgroFresh Inc., Collegeville, PA (US)

(72) Inventors: Christian Guy Becker, King of Prussia, PA (US); Richard Martin Jacobson, Chalfont, PA (US); Bridget Marie Stevens, Horsham, PA (US)

(21) Appl. No.: 14/409,845

(22) PCT Filed: Jun. 7, 2013
(86) PCT No.: PCT/US2013/044657

§ 371 Date: Dec. 19, 2014

Related U.S. Application Data
(60) Provisional application No. 61/661,935, filed on Jun. 20, 2012.

(51) Int. Cl. A01N 25/12; A01N 27/00; A01N 25/04

(52) U.S. Cl. CPC A01N 25/12; A01N 25/04; A01N 27/00

(57) ABSTRACT

Provided are methods for reducing the size of solid particles based on surprising results that storage with molecular sieves for a period of time can significantly reduce particle sizes. The solid particles may comprise an inclusion complex of a molecular encapsulating agent and a cyclopropene compound. The method comprises mixing a collection of the solid particles with molecular sieves and storing the mixture for a period of time.

### BACKGROUND

It is often desirable to reduce the particle size of a collection of solid particles. One benefit of reducing the size of solid particles is that, in many situations, doing so improves the stability of a dispersion of the solid particles in a liquid medium. In the past, common ways of reducing the particle size of a collection of solid particles were mechanical methods such as milling or grinding.

In some situations, mechanical methods of reducing particle size are undesirable. For example, some useful solid particles contain an inclusion complex of a molecular encapsulating agent and a cyclopropene compound. When such particles are subjected to milling, it is often observed that an undesirably large portion of the cyclopropene is lost from the complex.

D. M. Raut, et al. (“Dehydration of Lactose Monohydrate: Analytical and Physical Characterization,” Der Pharmacia Lettre, 2011, volume 3, number 5, pages 202-212) report that heating of lactose monohydrate causes dehydration, which in turn has various effects including reduced particle size. Heating of particles that contain cyclopropene in an inclusion complex would lead to loss of the cyclopropene.

It is desired to provide a method of reducing particles size of particles that contain an inclusion complex of a molecular encapsulating agent and a cyclopropene; it is desirable that the method does not involve any mechanical method of particle size reduction and that the method does not involve heating the particles. It is desirable that, after the reduction in size, it is possible to remove the cyclopropene compound conveniently.

### SUMMARY OF INVENTION

Provided are methods for reducing the size of solid particles based on surprising results that storage with molecular sieves for a period of time can significantly reduce particle sizes. The solid particles may comprise an inclusion complex of a molecular encapsulating agent and a cyclopropene compound. The method comprises mixing a collection of the solid particles with molecular sieves and storing the mixture for a period of time.

In one aspect, provided is a method for reducing the size of solid particles. The method comprises (a) providing a collection of the solid particles (b) preparing a mixture by mixing ingredients comprising the collection of the solid particles of step (a) and molecular sieves at a first temperature of 50° C. or lower; and (c) storing the mixture of step (b) for a pre-determined period of time at a second temperature of 50° C. or lower. In some embodiments, the solid particles of step (a) comprise an inclusion complex of a molecular encapsulating agent and a cyclopropene compound.

In one embodiment, the cyclopropene compound is of the formula:

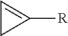

wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy. In another embodiment, R is C₁₋₈ alkyl. In another embodiment, R is methyl.

In another embodiment, the cyclopropene compound is of the formula:

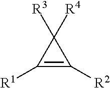

wherein R¹ is a substituted or unsubstituted C₁-C₄ alkyl, C₁-C₄ alkenyl, C₁-C₄ alkynyl, C₁-C₄ cycloalkyl, cylcoalkylalkyl, phenyl, or napthyl group; and R², R³, and R⁴ are hydrogen. In another embodiment, the cyclopropene comprises 1-methylcyclopropene (1-MCP).

In one embodiment, the molecular encapsulating agent comprises alpha-cyclodextrin, beta-cyclodextrin, gamma-cyclodextrin, or combinations thereof. In another embodiment, the molecular encapsulating agent comprises alpha-cyclodextrin.

In one embodiment, the mole ratio of the cyclopropene compound to the molecular encapsulating agent is 0.70:1 or higher in the collection of solid particles of step (a). In another embodiment, the mole ratio of the cyclopropene compound to the molecular encapsulating agent is from 0.9:1 to 1.1:1.

In one embodiment, the collection of solid particles of step (a) has LA50 of 25 μm (microns) or higher, wherein the LA50 is the area-weighted median length dimension, as observed in a two-dimensional image of a representative sample of the collection of solid particles of step (a). In s further embodiment, the method is with a proviso that particles which do not contain the inclusion complex of a molecular encapsulating agent and a cyclopropene compound are disregarded in the calculation of the LA50. In another embodiment, the collection of solid particles of step (a) has a LA50 from 25 μm to 100 μm (microns). In another embodiment, the collection of solid particles of step (a) has an ARA50 of 2:1 or higher, wherein the ARA50 is the area-weighted median aspect ratio, as observed in a two-dimensional image of a representative sample of the collection of solid particles of step (a). In a further embodiment, the method is with a proviso that particles which do not contain the inclusion complex of a molecular encapsulating agent and a cyclopropene compound are disregarded in the calculation of the ARA50. In another embodiment, the collection of solid particles of step (a) has an ARA50 from 2:1 to 10:1. In another embodiment, the method does not comprise any mechanical method of particle size reduction.

In one embodiment, the first temperature is from 4° C. to 40° C. In another embodiment, the first temperature is room temperature. In another embodiment, the second temperature is from 4° C. to 40° C. In another embodiment, the second temperature is room temperature. In another embodiment, the second temperature is lower than the first temperature. In a further embodiment, the second temperature is room temperature and the first temperature is 4° C. In another embodiment, the second temperature is the same as the first temperature. In another embodiment, the pre-determined period of time is one hour or longer. In another embodiment, the pre-determined period of time is at least three hours. In another embodiment, the pre-determined period of time is from three hours to forty-eight hours. In another embodiment, the pre-determined period of time is from three hours to twenty-four hours. In another embodiment, the sizes of the solid particles are reduced at least 2 folds. In another embodiment, the sizes of the solid particles are reduced from 2 folds to five folds.

In another aspect, provided is a collection of solid particles prepared from any embodiment of the method provided herein. In one embodiment, the collection of solid particles has a LA50 of 10 μm (microns) or lower. In another embodiment, the collection of solid particles has a LA50 from 3 μm to 10 μm (microns).

In another aspect, provided is a method of treating plants or plant parts comprising contacting said plants or plant parts with a composition comprising the collection of solid particles prepared from any embodiment of the method provided herein. In one embodiment, the collection of solid particles has a LA50 of 10 μm (microns) or lower. In another embodiment, the collection of solid particles has a LA50 from 3 μm to 10 μm (microns).

### DETAILED DESCRIPTION OF THE INVENTION

As used herein, material is said to be solid if it is in the solid state over a range of temperatures that includes at least 0° C. to 40° C.

As used herein, when a ratio is said to be “X:1 or higher,” that ratio is considered to be any ratio of Y:1 where Y is greater than or equal to X. For Example, if a ratio is said to be 3:1 or higher, that ratio may be, for example, 3:1 or 5:1 or 100:1, but it may not be, for example, 2:1. Similarly, when a ratio is said to be “A:1 or lower,” that ratio is any ratio B:1 where B is less than A.

As used herein, the quotient of two ratios is calculated as follows. First, both ratios are expressed in the form R:1. Then, for a first ratio of F:1 and a second ratio of S:1, the quotient of the first ratio divided by the second ratio is the number that results from dividing F by S.

Operations described herein, unless stated otherwise, are conducted at room temperature, which is approximately 25° C.

As used herein, the “aspect ratio” of a solid particle is the ratio of the particle's longest dimension to that particle's shortest dimension. A particle's longest dimension is the length of the longest possible line segment (“segment L”) that passes through the particle's center of mass and that has each of its end points on the surface of the particle. That particle's shortest dimension is the length of the shortest possible line segment (“segment S”) that passes through the particle's center of mass, that has each of its end points on the surface of the particle, and that is perpendicular to segment L. The aspect ratio is the ratio of the length of segment L to the length of segment S.

As used herein, the “diameter” of a non-spherical particle is the average of the length of that particle's segment L and that particle's segment S. It is noted that, when the particle is spherical, this definition gives the “diameter” in the usual sense.

As used herein, when a property of a powder is described as having a “median” value, it is contemplated that half of the total volume of powder particles will consist of particles that have that property with a value above that median value and that half of the total volume of powder particles will consist of particles that have that property with a value below that median value.

As used herein, a chemical group of interest is said to be “substituted” if one or more hydrogen atoms of the chemical group of interest is replaced by a substituent. Suitable substituents include, for example, alkyl, alkenyl, acetylamino, alkoxy, alkoxyalkoxy, alkoxycarbonyl, alkoxyimino, carboxy, halo, haloalkoxy, hydroxy, alkylsulfonyl, alkylthio, trialkylsilyl, dialkylamino, and combinations thereof.

The practice of the present invention involves the use of one or more cyclopropene compound. As used herein, a cyclopropene compound is any compound with

the formula

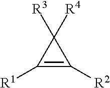

where each R¹, R², R³ and R⁴ is independently selected from the group consisting of H and a chemical group of the formula:

-(L)ₙ-Z

where n is an integer from 0 to 12. Each L is a bivalent radical. Suitable L groups include, for example, radicals containing one or more atoms selected from H, B, C, N, O, P, S, Si, or mixtures thereof. The atoms within an L group may be connected to each other by single bonds, double bonds, triple bonds, or mixtures thereof. Each L group may be linear, branched, cyclic, or a combination thereof. In any one R group (i.e., any one of R¹, R², R³ and R⁴) the total number of heteroatoms (i.e., atoms that are neither H nor C) is from 0 to 6.

Independently, in any one R group the total number of non-hydrogen atoms is 50 or less.

Each Z is a monovalent radical. Each Z is independently selected from the group consisting of hydrogen, halo, cyano, nitro, nitroso, azido, chlorate, bromate, iodate, isocyanato, isocyanido, isothiocyanato, pentafluorothio, and a chemical group G, wherein G is a 3 to 14 membered ring system.

Suitable R¹, R², R³, and R⁴ groups are independently, for example, substituted and unsubstituted versions of any one of the following groups: aliphatic, aliphatic-oxy, alkylcarbonyl, alkylphosphonato, alkylphosphato, alkylamino, alkylsulfonyl, alkylcarboxyl, alkylaminosulfonyl, cycloalkylsulfonyl, cycloalkylamino, heterocyclyl (i.e., aromatic or non-aromatic cyclic groups with at least one heteroatom in the ring), aryl, hydrogen, fluoro, chloro, bromo, iodo, cyano, nitro, nitroso, azido, chlorato, bromato, iodato, isocyanato, isocyanido, isothiocyanato, pentafluorothio; acetoxy, carboethoxy, cyanato, nitrato, nitrito, perchlorato, allenyl; butylmercapto, diethylphosphonato, dimethylphenylsilyl, isoquinolyl, mercapto, naphthyl, phenoxy, phenyl, piperidino, pyridyl, quinolyl, triethylsilyl, and trimethylsilyl.

Among the suitable R¹, R², R³, and R⁴ groups are those that contain one or more ionizable substituent groups. Such ionizable groups may be in non-ionized form or in salt form.

In preferred embodiments, one or more cyclopropene compound is used in which each of R¹, R², R³, and R⁴ is independently hydrogen or a substituted or unsubstituted alkyl, alkenyl, alkynyl, cycloalkyl, cycloalkylalkyl, phenyl, or naphthyl group; where the substituents, when present, are independently carboxyl, halogen, alkoxy, or substituted or unsubstituted phenoxy. In more preferred embodiments, one or more of R¹, R², R³, and R⁴ is hydrogen and each of R¹, R², R³, and R⁴ that is not hydrogen is independently a substituted or unsubstituted alkyl, alkenyl, alkynyl, cycloalkyl, cycloalkylalkyl, phenyl, or naphthyl group; where the substituents, when present, are independently carboxyl, halogen, alkoxy, or substituted or unsubstituted phenoxy.

In more preferred embodiments, each of R², R³, and R⁴ is hydrogen, and R¹ is hydrogen or an unsubstituted or substituted alkyl, alkenyl, alkynyl, cycloalkyl, cycloalkylalkyl, phenyl, or naphthyl group independently. Among such embodiments, more preferred are those in which R¹ is an alkyl group that has 1 to 10 carbon atoms and that is either unsubstituted or else is substituted with a carboxyl group; more preferred are those in which R¹ is unsubstituted alkyl having 1 to 8 carbon atoms; more preferred are those in which R¹ is unsubstituted alkyl having 1 to 3 carbon atoms; most preferably, R¹ is methyl.

In one embodiment, one or more of R¹, R², R³, and R⁴ is hydrogen or (C₁-C₁₀) alkyl. In another embodiment, each of R¹, R², R³, and R⁴ is hydrogen or (C₁-C₈) alkyl. In another embodiment, each of R¹, R², R³, and R⁴ is hydrogen or (C₁-C₄) alkyl. In another embodiment, each of R¹, R², R³, and R⁴ is hydrogen or methyl. In another embodiment, R¹ is (C₁-C₄) alkyl and each of R², R³, and R⁴ is hydrogen. In another embodiment, R¹ is methyl and each of R², R³, and R⁴ is hydrogen, and the cyclopropene compound is known herein as 1-methylcyclopropene or “1-MCP.”

In one embodiment, a cyclopropene compound can be used that has boiling point at one atmosphere pressure of 50° C. or lower; 25° C. or lower; or 15° C. or lower. In another embodiment, a cyclopropene compound can be used that has boiling point at one atmosphere pressure of −100° C. or higher; −50° C. or higher; −25° C. or higher; or 0° C. or higher.

The compositions disclosed herein include at least one molecular encapsulating agent. In preferred embodiments, at least one molecular encapsulating agent encapsulates one or more cyclopropene compound or a portion of one or more cyclopropene compound. A complex that includes a cyclopropene compound molecule or a portion of a cyclopropene compound molecule encapsulated in a molecule of a molecular encapsulating agent is known herein as a “cyclopropene compound complex” or “cyclopropene molecular complex.”

In one embodiment, at least one cyclopropene compound complex is present that is an inclusion complex. In a further embodiment for such an inclusion complex, the molecular encapsulating agent forms a cavity, and the cyclopropene compound or a portion of the cyclopropene compound is located within that cavity.

In another embodiment for such inclusion complexes, the interior of the cavity of the molecular encapsulating agent is substantially apolar or hydrophobic or both, and the cyclopropene compound (or the portion of the cyclopropene compound located within that cavity) is also substantially apolar or hydrophobic or both. While the present invention is not limited to any particular theory or mechanism, it is contemplated that, in such apolar cyclopropene compound complexes, van der Waals forces, or hydrophobic interactions, or both, cause the cyclopropene compound molecule or portion thereof to remain within the cavity of the molecular encapsulating agent.

Suitable molecular encapsulating agents include, for example, organic and inorganic molecular encapsulating agents. Suitable organic molecular encapsulating agents include, for example, substituted cyclodextrins, unsubstituted cyclodextrins, and crown ethers. Suitable inorganic molecular encapsulating agents include, for example, zeolites. Mixtures of suitable molecular encapsulating agents are also suitable. In one embodiment, the molecular encapsulating agent comprises alpha-cyclodextrin, beta-cyclodextrin, gamma-cyclodextrin, or combinations thereof. In a further embodiment, the molecular encapsulating agent comprises alpha-cyclodextrin.

The cyclopropene compound complex can usefully be characterized by the ratio of moles of cyclopropene to moles of molecular encapsulating agent. The mole ratio of cyclopropene to molecular encapsulating agent can be 0.7:1 or higher; 0.8:1 or higher; 0.9:1 or higher; or 0.95:1 or higher. Independently, prior to performing the method of the present invention, the mole ratio of cyclopropene to molecular encapsulating agent can be 1.1:1 or lower. In one embodiment, the mole ratio of cyclopropene to molecular encapsulating agent is from 0.9:1 to 1.1:1.

It is sometimes useful to characterize a collection of particles by observing the size of the particles. One useful method is the “image” method, which is performed as follows. A representative sample of the particles of the collection of interest is spread out upon a flat surface so that all or nearly all of the particles in the sample are not overlapping any other particle. The particles are then observed, for example by making a two-dimensional image of the particles, for example by optical microscopy. The image of each particle is observed, and the area of the image of each particle is recorded.

Additionally, the image of each particle is observed to determine its width dimension, which is defined herein as the length of the shortest radial line segment of the image of that particle. A “radial line segment” as used herein is a line segment that passes through the geometric center of the image of the particle and that has its endpoints on the perimeter of the image of the particle.

As used herein, the length dimension of the image of a particle is defined herein as the length of the radial line segment of the image of the particle that is perpendicular to the shortest radial line segment. In some cases, the image of a particle is rectangular or nearly rectangular, and a useful estimate of the area of the image is formed by multiplying the width dimension times the length dimension.

A collection of particles may be usefully characterized by a parameter herein called LA50, the area-weighted median length dimension, which is defined herein as follows. Using the image method described herein above, the images of the particles are examined. LA50 is determined as the value that makes the following true: the total area of the images of all the particles having length dimension of LA50 or above is half of the total area of the images of all the particles in the sample.

Similarly, WA50, the area-weighted width dimension is determined as the value that makes the following true: the total area of the images of all the particles having width dimension of WA50 or above is half of the total area of the images of all the particles in the sample. Similarly, ARA50, the area-weighted aspect ratio, is determined as the value that makes the following true: the total area of the images of all the particles having aspect ratio of ARA50 or above is half of the total area of the images of all the particles in the sample.

The particles in the sample will have some depth dimension, measured perpendicular to the plane of the image. While not limiting the present invention to any particular assumption about the depth dimension of the particles, it is contemplated that the image areas of the particles, as defined above, will correlate with the volumes and the masses of the particles. Therefore it is contemplated that the image area method as defined above will provide a useful assessment of collections of particles in which a relatively large amount of the mass or volume of the sample exists in the form of relatively large particles.

The present invention involves providing an initial collection of cyclopropene compound complex particles. The LA50 of the initial collection of cyclopropene compound complex particles is herein called “LA50(initial).” LA50(initial) is preferably 25 μm (microns) or higher; more preferably 50 μm (microns) or higher. Preferably, LA50(initial) is 1 mm or smaller. The ARA50 of the initial collection of cyclopropene compound complex particles is herein called “ARA50(initial).” In some embodiments, the ARA50(initial) can be 2:1 or higher; 3:1 or higher; or 10:1 or higher. In some embodiments, the ARA50(initial) can be 20:1 or smaller; 10:1 or smaller; or 5:1 or smaller.

When LA50(initial) or ARA50(initial) of an initial collection of cyclopropene compound complex particles is assessed, if any particles are present that are not made of cyclopropene compound complex, such particles are disregarded. A particle is considered herein to be “made of cyclopropene compound complex” if 50% or more by weight of that particle, based on the weight of that particle, is cyclopropene compound complex. If any particles that are not made of cyclopropene compound complex are present, the images of the areas of such particles do not contribute to the total area of the images of particles, and the length and width dimensions of such particles are not measured or considered in the calculation of LA50(initial) or ARA50(initial).

The initial collection of cyclopropene compound complex particles preferably contains few or no particles that are not made of cyclopropene compound complex. Preferably, the amount of particles that are not made of cyclopropene compound complex is, by weight based on the weight of the initial collection of cyclopropene compound complex particles, 0% to 10%; more preferably 0% to 5%; more preferably 0% to 2%; more preferably 0% to 1%.

The initial collection of cyclopropene compound complex particles preferably contains water in an amount that greater than 0% and is 10% or less by weight based on the weight of the composition. Preferably, the amount of water, by weight based on the weight of the initial collection of cyclopropene compound complex particles, is 8% or less; or 6% or less. Preferably, the amount of water, by weight based on the weight of the initial collection of cyclopropene compound complex particles, is 2% or more; or 4% or more.

In preferred embodiments of the present invention, the initial collection of cyclopropene compound complex particles is in the form a powder.

The present invention involves the use of molecular sieves. Molecular sieves are crystalline materials that have three-dimensional pores of uniform size. Preferred molecular sieves are zeolite molecular sieves; more preferred are zeolite molecular sieves having type A structure. Preferred molecular sieves have characteristic pore size of 3 Ångstrom or larger. Preferred molecular sieves have characteristic pore size of 4 Ångstrom or smaller.

In the practice of the present invention, a mixture is made by bringing the initial collection of cyclopropene compound complex particles into contact with molecular sieves and optionally one or more additional ingredient. It is contemplated that some mechanical force will be applied to the mixture to thoroughly blend the ingredients; it is also contemplated that the mechanical force that is so applied will be insufficient to cause, by itself, the initial collection of cyclopropene compound complex particles to undergo any significant amount of particle fracture or other mechanically induced process of particle size reduction.

In the mixture of the initial collection of cyclopropene compound complex particles with molecular sieves, the ratio of the weight of the cyclopropene compound complex particles to the weight of molecular sieves is preferably 15:1 or lower; more preferably 10:1 or lower; more preferably 5:1 or lower. The presence of a relatively high proportion of molecular sieves in the mixture of the initial collection of cyclopropene compound complex particles with molecular sieves is not expected to interfere with the process of reducing particle size. Therefore, is contemplated that there is no lower limit in the practice of the present invention to the ratio of the weight of the cyclopropene compound complex particles to the weight of molecular sieves in the mixture of the initial collection of cyclopropene compound complex particles with molecular sieves. In some embodiments, the mixture of the initial collection of cyclopropene compound complex particles with molecular sieves, the ratio of the weight of the cyclopropene compound complex particles to the weight of molecular sieves is 0.5:1 or higher; or 1:1 or higher; or 2:1 or higher.

The step of making the mixture of the initial collection of cyclopropene compound complex particles with molecular sieves is performed at a temperature of 50° C. or lower; preferably 40° C. or lower; more preferably 30° C. or lower. The step of making the mixture of the initial collection of cyclopropene compound complex particles with molecular sieves is preferably performed at a temperature of 5° C. or higher; more preferably 10° C. or higher; more preferably 15° C. or higher.

The mixture of the initial collection of cyclopropene compound complex particles with molecular sieves can be stored for a period of storage of 1 hour or longer, starting at the time the mixture is first formed, at a temperature of 50° C. or lower. After this period of storage, the mixture is considered herein to be a mixture of molecular sieves with a final collection of cyclopropene compound complex particles. The particles in the final collection of cyclopropene compound complex particles contain inclusion complex of a molecular encapsulating agent and a cyclopropene compound, and the size of the particles in the final collection of cyclopropene compound complex particles is smaller than the particles in the initial collection of particles.

The period of storage is preferably 2 hours or longer; more preferably 5 hours or longer; more preferably 10 hours or longer; more preferably 20 hours or longer. The temperature during the period of storage is preferably 40° C. or lower; more preferably 30° C. or lower. The temperature during the period of storage is preferably 5° C. or higher; more preferably 10° C. or higher; more preferably 15° C. or higher.

While the present invention is not limited to any particular theory, it is contemplated that the reduction of the cyclopropene compound complex particle size occurs as follows. Solid particles of cyclopropene compound complex normally contain a few percent by weight of water, and the water molecules are believed to be part of the crystal structure of the particles of cyclopropene compound complex. When such particles are mixed with molecular sieves, and the mixture is then stored, it is contemplated that water migrates from the crystals of cyclopropene compound complex to the pores in the molecular sieves. This loss of water from the crystals of cyclopropene compound complex is contemplated to cause the crystals to fracture, thus reducing the particle size.

Preferably, the cyclopropene compound complex particles are not subjected at any time, before or after mixing with molecular sieves, to milling or grinding or any other process that is normally used for reduction of particle size. More preferably, the cyclopropene compound complex particles are not subjected at any time, before or after mixing with molecular sieves, to any mechanical force that causes, by itself, significant reduction of particle size. Significant reduction in particle size is considered herein to mean that the quotient from dividing the LA50 after the mechanical force by the LA50 before the mechanical force is 0.8 or lower.

After the period of storage, the collection of final cyclopropene compound complex particles has LA50, herein called LA50(final). Preferably, LA50(final) is 15 μm (microns) or lower; more preferably 10 μm (microns) or lower. The collection of particles that exists after the period of storage is known herein as the final collection of particles.

As in the case of LA50(initial), when LA50(final) is assessed, if any particles are present that are not made of cyclopropene compound complex, such particles are disregarded.

It is useful to characterize the extent to which the cyclopropene compound is retained in the composition when the method of the present invention is performed. This extent of retention is characterized herein by using the mole ratio of cyclopropene compound to molecular encapsulating agent. That mole ratio is found for the collection of initial particles and is found again for the final collection of particles. Preferably, the quotient of dividing the mole ratio of the final collection of particles by the mole ratio of the initial collection of particles is 0.91 or higher; more preferably 0.95 or higher.

The particles that contain cyclopropene compound complex may be used for any purpose. In some desirable uses, the complex provides a stable medium for the cyclopropene compound during storage, handling, and/or transport. It may be desired to release the cyclopropene compound from the complex at a particular time, often after such storage, handling, and/or transport.

For example, when the cyclopropene is 1-methyl cyclopropene (1-MCP) and the molecular encapsulating agent is alpha-cyclodextrin (a-CD), it is often desirable to release 1-MCP from the complex when the complex is in the vicinity of, or in contact with, a plant or plant part. That is, it is desirable that the 1-MCP retain the ability to release from the complex and come into contact with a plant or plant part.

In some cases, it is desired to disperse particles of cyclopropene compound complex in an oil. In such cases, it is desired to use relatively small particles of cyclopropene compound complex so that the particles can be dispersed properly in the oil. When making such a dispersion of cyclopropene compound complex particles in oil, it is preferable to make a mixture that contains only cyclopropene compound complex particles and molecular sieves, store that mixture for 1 day or more to allow the particle size to reduce, and then combine that mixture with oil.

In the practice of the present invention, one or more oils are used. As used herein, the phrase “oil” refers to a compound that is liquid at 25° C. and 1 atmosphere pressure and that has a boiling point at 1 atmosphere pressure of 30° C. or higher. As used herein, “oil” does not include water, does not include surfactants, and does not include dispersants.

In some embodiments, one or more oil may be used that has boiling point of 50° C. or higher; or 75° C. or higher; or 100° C. or higher. In some embodiments, every oil that is used has boiling point of 50° C. or higher. In some embodiments, every oil that is used has boiling point of 75° C. or higher. In some embodiments, every oil that is used has boiling point of 100° C. or higher. Independently, in some of the embodiments that use oil, one or more oil may be used that has an average molecular weight of 100 or higher; or 200 or higher; or 500 or higher. In some embodiments, every oil that is used has average molecular weight of 100 or higher. In some embodiments, every oil that is used has average molecular weight of 200 or higher. In some embodiments, every oil that is used has average molecular weight of 500 or higher.

An oil may be either a hydrocarbon oil (i.e., an oil whose molecule contains only atoms of carbon and hydrogen) or a non-hydrocarbon oil (i.e., an oil whose molecule contains at least at least one atom that is neither carbon nor hydrogen).

Some suitable hydrocarbon oils are, for example, straight, branched, or cyclic alkane compounds with 6 or more carbon atoms. Some other suitable hydrocarbon oils, for example, have one or more carbon-carbon double bond, one or more carbon-carbon triple bond, or one or more aromatic ring, possibly in combination with each other and/or in combination with one or more alkane group. Some suitable hydrocarbon oils are obtained from petroleum distillation and contain a mixture of compounds, along with, in some cases, impurities. Hydrocarbon oils obtained from petroleum distillation may contain a relatively wide mixture of compositions or may contain relatively pure compositions. In some embodiments, hydrocarbon oils are used that contain 6 or more carbon atoms. In some embodiments, hydrocarbon oils are used that contain 18 or fewer carbon atoms. In some embodiments, every hydrocarbon oil that is used contains 18 or fewer carbon atoms. In some embodiments, every hydrocarbon oil that is used contains 6 or more carbon atoms. Some suitable hydrocarbon oils include, for example, hexane, decane, dodecane, hexadecane, diesel oil, refined paraffinic oil (e.g., Ultrafine™ spray oil from Sun Company), and mixtures thereof. In some embodiments, every oil that is used is a hydrocarbon oil.

Among embodiments that use non-hydrocarbon oil, some suitable non-hydrocarbon oils are, for example, fatty non-hydrocarbon oils. “Fatty” means herein any compound that contains one or more residues of fatty acids. Fatty acids are long-chain carboxylic acids, with chain length of at least 4 carbon atoms. Typical fatty acids have chain length of 4 to 18 carbon atoms, though some have longer chains. Linear, branched, or cyclic aliphatic groups may be attached to the long chain. Fatty acid residues may be saturated or unsaturated, and they may contain functional groups, including for example alkyl groups, epoxide groups, halogens, sulfonate groups, or hydroxyl groups, that are either naturally occurring or that have been added. Some suitable fatty non-hydrocarbon oils are, for example, fatty acids; esters of fatty acids; amides of fatty acids; dimers, trimers, oligomers, or polymers thereof; and mixtures thereof.

Some of the suitable fatty non-hydrocarbon oils, are, for example, esters of fatty acids. Such esters include, for example, glycerides of fatty acids. Glycerides are esters of fatty acids with glycerol, and they may be mono-, di-, or triglycerides. A variety of triglycerides are found in nature. Most of the naturally occurring triglycerides contain residues of fatty acids of several different lengths and/or compositions. Some suitable triglycerides are found in animal sources such as, for example, dairy products, animal fats, or fish. Further examples of suitable triglycerides are oils found in plants, such as, for example, coconut, palm, cottonseed, olive, tall, peanut, safflower, sunflower, corn, soybean, linseed, tung, castor, canola, citrus seed, cocoa, oat, palm, palm kernel, rice bran, cuphea, or rapeseed oil.

Among the suitable triglycerides, independent of where they are found, are those, for example, that contain at least one fatty acid residue that has 14 or more carbon atoms. Some suitable triglycerides have fatty acid residues that contain 50% or more by weight, based on the weight of the residues, fatty acid residues with 14 or more carbon atoms, or 16 or more carbon atoms, or 18 or more carbon atoms. One example of a suitable triglyceride is soybean oil.

Suitable fatty non-hydrocarbon oils may be synthetic or natural or modifications of natural oils or a combination or mixture thereof. Among suitable modifications of natural oils are, for example, alkylation, hydrogenation, hydroxylation, alkyl hydroxylation, alcoholysis, hydrolysis, epoxidation, halogenation, sulfonation, oxidation, polymerization, and combinations thereof. In some embodiments, alkylated (including, for example, methylated and ethylated) oils are used. One suitable modified natural oil is methylated soybean oil.

Also among the suitable fatty non-hydrocarbon oils are self-emulsifying esters of fatty acids.

Another group of suitable non-hydrocarbon oils is the group of silicone oils. Silicone oil is an oligomer or polymer that has a backbone that is partially or fully made up of —Si—O— links. Silicone oils include, for example, polydimethylsiloxane oils. Polydimethylsiloxane oils are oligomers or polymers that contain units of the form

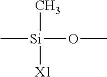

where at least one of the units has X1=CH₃. In other units, X1 may be any other group capable of attaching to Si, including, for example, hydrogen, hydroxyl, alkyl, alkoxy, hydroxyalkyl, hydroxyalkoxy, alkylpolyalkoxyl, substituted versions thereof, or combinations thereof. Substituents may include, for example, hydroxyl, alkoxyl, polyethoxyl, ether linkages, ester linkages, amide linkages, other substituents, or any combination thereof. In some embodiments, every oil that is used is a silicone oil.

In some suitable polydimethylsiloxane oils, all X1 groups are groups that are not hydrophilic. In some suitable polydimethylsiloxane oils, all X1 groups are alkyl groups. In some suitable polydimethylsiloxane oils, all X1 groups are methyl. In some embodiments, every silicone oil is a polydimethylsiloxane oil in which all X1 groups are methyl. In some suitable polydimethylsiloxanes, at least one unit has an X1 group that is not methyl; if more than one non-methyl X1 unit is present, the non-methyl X1 units may be the same as each other, or two or more different non-methyl X1 units may be present. Polydimethylsiloxane oils may be end-capped with any of a wide variety of chemical groups, including, for example, hydrogen, methyl, other alkyl, or any combination thereof. Also contemplated are cyclic polydimethylsiloxane oils. Mixtures of suitable oils are also suitable.

Such a dispersion of cyclopropene compound complex particles in oil may be, for example, brought into contact with plants or plant parts. For another example, droplets of such a dispersion of cyclopropene compound complex particles in oil may be themselves suspended in water, and the resulting complicated mixture may be brought into contact with plants or plant parts.

Plants or plant parts may be treated in the practice of the present invention. One example is treatment of whole plants; another example is treatment of whole plants while they are planted in soil, prior to the harvesting of useful plant parts.

Any plants that provide useful plant parts may be treated in the practice of the present invention. Examples include plants that provide fruits, vegetables, and grains.

As used herein, the phrase “plant” includes dicotyledons plants and monocotyledons plants. Examples of dicotyledons plants include tobacco, Arabidopsis, soybean, tomato, papaya, canola, sunflower, cotton, alfalfa, potato, grapevine, pigeon pea, pea, Brassica, chickpea, sugar beet, rapeseed, watermelon, melon, pepper, peanut, pumpkin, radish, spinach, squash, broccoli, cabbage, carrot, cauliflower, celery, Chinese cabbage, cucumber, eggplant, and lettuce. Examples of monocotyledons plants include corn, rice, wheat, sugarcane, barley, rye, sorghum, orchids, bamboo, banana, cattails, lilies, oat, onion, millet, and triticale. Examples of fruit include papaya, banana, pineapple, oranges, grapes, grapefruit, watermelon, melon, apples, peaches, pears, kiwifruit, mango, nectarines, guava, persimmon, avocado, lemon, fig, and berries.

A first aspect of the present invention is a method for reducing the size of solid particles, wherein said particles comprise an inclusion complex of a molecular encapsulating agent and a cyclopropene compound, wherein said method comprises (A) providing an initial collection of said particles, (B) then making a mixture by bringing into contact ingredients comprising said initial collection of said particles and molecular sieves, (C) then storing said mixture for 1 hour or longer, wherein said steps (B) and (C) are performed at 50° C. or lower.

A second aspect of the present invention is a final collection of particles formed by the method of the first aspect, wherein said final collection of said particles has LA50(final) of 10 μm (microns) or lower, wherein said LA50(final) is the area-weighted median length dimension, as observed in a two-dimensional image of a representative sample of said final collection of said particles, with the proviso that particles that are not made of said inclusion complex of a molecular encapsulating agent and a cyclopropene compound are disregarded in the calculation of said LA50(final).

### EXAMPLES

Operations were all conducted at room temperature (approximately 25° C.) unless otherwise noted. The materials listed in Table 1 are used:

TABLE 1
List of materials used in Examples.

| Label | Material | Supplier |
|---|---|---|
| 1-MCP | 1-methylcyclopropene | The Dow Chemical |
| | | Company |
| a-CD | alpha-cyclodextrin | Wacker Company |
| MS-1 | Siliporite ™ NK 10 AP Powder⁽¹⁾ | CECA Company |
| MS-2 | Siliporite ™ NK 30 AP Powder⁽²⁾ | CECA Company |
| MS-3 | Siliporite ™ NK 30 beads⁽³⁾ | CECA Company |
| Powder1 | Encapsulation Complex⁽⁴⁾ | The Dow Chemical |
| | | Company |
| Charcoal | GetterPak ™ adsorbent⁽⁵⁾ | Sudchemie |
| Clay-1 | LVM red 24/48 (fine particles)⁽⁶⁾ | Oil-Dry Corporation |
| Clay-2 | LVM gray 16/30 (medium particles)⁽⁶⁾ | Oil-Dry Corporation |
| Clay-3 | LVM red 8/16 (coarse particles)⁽⁶⁾ | Oil-Dry Corporation |

Note
⁽¹⁾synthetic zeolite type A, sodium form, effective pore size 4 Ångstrom, powder having weight-weighted median particle size less than 20 μm (microns).
Note
⁽²⁾synthetic zeolite type A, potassium/sodium form, effective pore size 3 Ångstrom, powder having weight-weighted median particle size less than 20 μm (microns).
Note
⁽³⁾synthetic zeolite type A potassium/sodium form, effective pore size 3 Ångstrom, beads having weight-weighted median particle size of between 2.5 and 5.0 mm.
Note
⁽⁴⁾powder containing (approximate % by weight based on the weight of Powder1) water (6%), and inclusion complex of 1-MCP in a-CD. Level of 1-MCP was 4.5%; level of a-CD was 89.5%.
Note
⁽⁵⁾charcoal was removed from the adsorbent packets and used as a powder.
Note
⁽⁶⁾Montmorillonite clay from Ripley, MS or Mounds, IL. Heat treated for hardness.

### Example 1

### Adsorption of 1-MCP Gas

In order to assess the tendency of various powders to adsorb 1-MCP, the following experiment is performed. Three bottles are prepared. Each has capacity of 255 ml and each has a septum cap. One gram of desiccant is added to each bottle, and the bottle is capped. 5 ml of concentrated 1-MCP gas is injected into each bottle. Immediately after injection (“time zero”), an aliquot of the headspace gas is removed. Further aliquots are removed at various times, including 5 hours and 120 hours after injection. The aliquots are analyzed for 1-MCP content, and the 1-MCP content of the headspace in each bottle is calculated. The results are shown in Table 2, where MS-2 adsorbs some of the 1-MCP gas but not all. Charcoal adsorbs the 1-MCP gas completely and quickly.

TABLE 2
Concentration of 1-MCP in Headspace (ppm)

| Desiccant | time zero | 5 hours | 120 hours |
|---|---|---|---|
| none | 18,000 | 18,000 | 18,000 |
| MS-2 | 14,000 | 8,000 | 4,500 |
| charcoal | 0 | 0 | 0 |

### Example 2

### Use of MS-1 Powder

Blends are made of Powder1 with MS-1 powder (molecular sieves, 4 Ångstrom). The proportion is 100 parts by weight of Powder1 to 30 parts by weight of MS-1 powder. After various periods of storage, the 1-MCP content is determined.

Blend 2A: The initial concentration of 1-MCP in Powder1 is 4.82% by weight based on the weight of Powder1. The ratio of Powder1 to MS-1 is 3.33:1. After mixing, if there is no loss of 1-MCP, the expected concentration of 1-MCP in the blend should be 3.71% by weight based on the weight of the blend. After storage, the concentration of 1-MCP in the blend is measured and shown in Table 3.

TABLE 3
Concentration of 1-MCP in Blend 2A (weight % based
on the weight of Blend 2A)

| Duration of Storage | weight % 1-MCP |
|---|---|
| 90 minutes | 3.71% |
| 24 hours | 3.67% |

Blend 2B: The initial concentration of 1-MCP in Powder1 is 4.82% by weight based on the weight of Powder1. The ratio of Powder1 to MS-1 is 3:1. After mixing, if there is no loss of 1-MCP, the expected concentration of 1-MCP in the blend should be 3.62% by weight based on the weight of the blend. After storage for 2 months, the concentration of 1-MCP in the blend is as 3.52%, by weight based on the weight of Blend 2B.

The method for determining the 1-MCP content is as follows. A weighed portion of powder is placed in a 250 ml bottle with a septum cap. 2 to 3 ml of water is injected, to release 1-MCP from encapsulation complex. 250 μL of cis-2-butene is injected as an internal standard. The bottle is agitated for approximately 30 minutes. At various times thereafter, an aliquot of 500 μL is removed from the headspace gas and analyzed by gas chromatography using a PoraBond™ Q column (Agilent Technologies). The amount of powder is chosen so that the concentration of 1-MCP in the headspace gas can be approximately 1,000 ppm vol/vol (the concentration of 1-MCP is always less than 2,000 ppm vol/vol). From the gas chromatography result, comparison of the 1-MCP peak area to the cis-2-butene peak area provides the concentration of 1-MCP in the headspace gas, from which the concentration of 1-MCP in the powder is determined.

In both Blend 2A and Blend 2B, the mixture of Powder1 and MS-1 retains nearly all the 1-MCP during storage, and the 1-MCP is available to be released after storage.

The mixture of Powder1 and MS-1 is also examined after various storage periods by optical microscopy. The mixture is diluted in propylene carbonate; a thin layer is applied to a glass slide and examined by optical microscopy at magnification 400×. Both the particles of cyclopropene compound complex powder and particles of MS-1 are visible. The particles of cyclopropene compound complex can be distinguished by their rectangular shape. The results are shown in Table 4, where the size of the Powder1 particles appears desirably reduced during the storage period.

TABLE 4
Observations over time.

| Storage | |
|---|---|
| Period | Observations of Powder1 particles |
| zero | Many large, roughly rectangular particles with high aspect |
| | ratio. LA50 larger than 25 μm. ARA50 larger than 2:1. |
| 15 minutes | Many particles appear to have broken into smaller particles |
| 30 minutes | Process of breaking particles appears to continue; particles |
| | are smaller than at 15 min. |
| 1 hour | Process of breaking particles appears to continue; particles |
| | are smaller than at 30 min. |
| 3 hours | Process of breaking particles appears to continue; particles |
| | are smaller than at 1 hour. LA50 less than 10 μm. |
| 6 hours | Process of breaking particles appears to continue; particles |
| | are smaller than at 3 hours. |
| 24 hours | Process of breaking particles appears to continue; particles |
| | are smaller than at 6 hours. |

### Example 3

### Clays

Mixtures are made using 100 parts by weight Powder1 and 30 parts by weight clay. Mixtures of Powder1 with clay can retain 1-MCP as well as the mixtures of Powder1 with molecular sieves do. The mixtures of Powder1 and clays are examined by optical microscopy. After 24 hours, no evidence is found for any particle breakage or particle size reduction.

### Example 4

### Molecular Sieves

Mixtures are made using 100 parts by weight of Powder1 and 30 parts by weight molecular sieves. MS-1, MS-2, and MS-3 are used. Optical microscopy is performed but the diluent is a light petroleum distillate (Unipar™ SH 210 AS solvent, from Unisource Energy Inc.). MS-1 and MS-2 provide the same results as Example 2. In the mixture with MS-3, after 24 hours, the Powder1 particles are significantly reduced in size, with LA50 of less than 10 μm (microns).

### Example 5

### Mechanical Size Reduction

Powder1 is mixed with oil and milled in a bead mill as follows. The following ingredients are mixed: hydrocarbon oil (581 g), dispersant (37.5 g), anionic surfactant (3.75 g), silicone surfactant (18.75 g), Powder1 (817.5 g), ethylenediaminetetraacetic acid (6.00 g), fumed silica (33.75 g, dispersed into other ingredients for 5 minutes using a Silverson mixer), dye solution in oil (1.50 g). The ingredients are processed in a 750 ml Eiger bead mill for 10 minutes at 3000 rpm. After milling, the 1-MCP content is measured by adding water to release 1-MCP into a confined headspace and using gas chromatography as above. The quotient of the mole ratio of cyclopropene compound to molecular encapsulating agent after milling, divided by the mole ratio of cyclopropene compound to molecular encapsulating agent before milling is 0.85.

Powder1 is also subject to air milling. The quotient of the mole ratio of cyclopropene compound to molecular encapsulating agent after milling, divided by the mole ratio of cyclopropene compound to molecular encapsulating agent before milling is 0.89.

### Example 6

### Heating

Powder1 is stored at 80° C. for approximately 16 hours. The quotient of the mole ratio of cyclopropene compound to molecular encapsulating agent after storage at 80° C., divided by the mole ratio of cyclopropene compound to molecular encapsulating agent before storage at 80° C. is less than 0.8. Powder1 is stored at temperatures higher than 80° C. for times shorter than 16 hours. In each case, the quotient of the mole ratio of cyclopropene compound to molecular encapsulating agent after storage, divided by the mole ratio of cyclopropene compound to molecular encapsulating agent before storage is less than 0.8.

We claim:

1. A method for reducing the size of solid particles, comprising:
(a) providing a collection of the solid particles;
(b) preparing a mixture by mixing ingredients comprising the collection of the solid particles of step (a) and molecular sieves at a first temperature of 50° C. or lower; and
(c) storing the mixture of step (b) for a pre-determined period of time at a second temperature of 50° C. or lower.

2. The method of claim 1, wherein the solid particles of step (a) comprise an inclusion complex of a molecular encapsulating agent and a cyclopropene compound.

3. The method of claim 2, wherein the cyclopropene compound is of the formula: 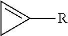
wherein R is a substituted or unsubstituted alkyl, alkenyl, alkynyl, cycloalkyl, cycloalkylalkyl, phenyl, or naphthyl group; wherein the substituents are independently halogen, alkoxy, or substituted or unsubstituted phenoxy.

4. The method of claim 3, wherein R is C₁₋₈ alkyl.

5. The method of claim 3, wherein R is methyl.

6. The method of claim 2, wherein the cyclopropene compound is of the formula: 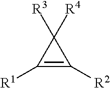
wherein R¹ is a substituted or unsubstituted C₁-C₄ alkyl, C₁-C₄ alkenyl, C₁-C₄ alkynyl, C₁-C₄ cycloalkyl, cylcoalkylalkyl, phenyl, or napthyl group; and R², R³, and R⁴ are hydrogen.

7. The method of claim 6, wherein the cyclopropene compound comprises 1-methylcyclopropene (1-MCP).

8. The method of claim 2, wherein the molecular encapsulating agent comprises alpha-cyclodextrin, beta-cyclodextrin, gamma-cyclodextrin, or combinations thereof.

9. The method of claim 2, wherein the molecular encapsulating agent comprises alpha-cyclodextrin.

10. The method of claim 2, wherein the mole ratio of the cyclopropene compound to the molecular encapsulating agent is 0.70:1 or higher in the collection of solid particles of step (a).

11. The method of claim 10, wherein the mole ratio of the cyclopropene compound to the molecular encapsulating agent is from 0.9:1 to 1.1:1.

12. The method of claim 2, wherein the collection of solid particles of step (a) has LA50 of 25 μm or higher,
wherein the LA50 is the area-weighted median length dimension, as observed in a two-dimensional image of a representative sample of the collection of solid particles of step (a).

13. The method of claim 12, with a proviso that particles which do not contain the inclusion complex of a molecular encapsulating agent and a cyclopropene compound are disregarded in the calculation of the LA50.

14. The method of claim 12, wherein the collection of solid particles of step (a) has a LA50 from 25 μm to 100 μm.

15. The method of claim 2, wherein the collection of solid particles of step (a) has an ARA50 of 2:1 or higher.
wherein the ARA50 is the area-weighted median aspect ratio, as observed in a two-dimensional image of a representative sample of the collection of solid particles of step (a).

16. The method of claim 15, with a proviso that particles which do not contain the inclusion complex of a molecular encapsulating agent and a cyclopropene compound are disregarded in the calculation of the ARA50.

17. The method of claim 2, wherein the collection of solid particles of step (a) has an ARA50 from 2:1 to 10:1.

18. The method of claim 1, wherein the method does not comprise any mechanical method of particle size reduction.

19. The method of claim 1, wherein the first temperature is from 4° C. to 40° C.

20. The method of claim 1, wherein the second temperature is from 4° C. to 40° C.

21. The method of claim 1, wherein the pre-determined period of time is one hour or longer.

22. The method of claim 1, wherein the pre-determined period of time is at least three hours.

23. The method of claim 1, wherein the pre-determined period of time is from three hours to forty-eight hours.

24. The method of claim 1, wherein the sizes of the solid particles are reduced at least 2 folds.

25. The method of claim 1, wherein the sizes of the solid particles are reduced from 2 folds to five folds.

26. A collection of solid particles prepared from the method of claim 1.

27. The collection of solid particles of claim 26, having a LA50 of 10 μm or lower.

28. The collection of solid particles of claim 26, having a LA50 from 3 μm to 10 μm.

29. A method of treating plants or plant parts comprising contacting said plants or plant parts with a composition comprising the collection of solid particles of claim 26.
